(19) United States
(12) Patent Application Publication
(10) Pub. No.: US 2011/0309036 A1
(43) Pub. Date: Dec. 22, 2011

(54) Filter

(76) Inventors: Abul Hussam, Centreville, VA (US); Sad Ahamed, Fairfax, VA (US); Abul K. Munir, Kushtia (BD)

(21) Appl. No.: 12/966,457

(22) Filed: Dec. 13, 2010

Related U.S. Application Data
(60) Provisional application No. 61/285,635, filed on Dec. 11, 2009.

(51) Int. Cl. B01D 35/00; B05D 5/00

(52) U.S. Cl. 210/767; 210/508; 427/244

(57) ABSTRACT

Filter compositions, filter apparatuses and/or processes thereof. A filter composition may include an active material and/or a support material. An active material may include metal and/or non-metal components, for example iron, manganese, carbon, phosphorous, aluminum, silicon, cerium, sulfur, chromium, copper and/or zinc. A support material may include one or more polymers. A plurality of fibers may be in the form of a matrix, for example a fabric matrix. An active material may be embedded in a support material. An active material may include particles having an average diameter less than approximately 250 μm. Embedded particles may be present in an amount greater than approximately 1.0 g/m². A filtration capacity of approximately 30 mg of target per gram of embedded active material may be exhibited. A filter composition may be disposed in a housing. A filter process may include allowing a target to contact a filter composition.

The present application claims priority to U.S. Provisional Patent Application No. 61/285,635 (filed on Dec. 11, 2009), which is hereby incorporated by reference in its entirety.

### DRAWINGS

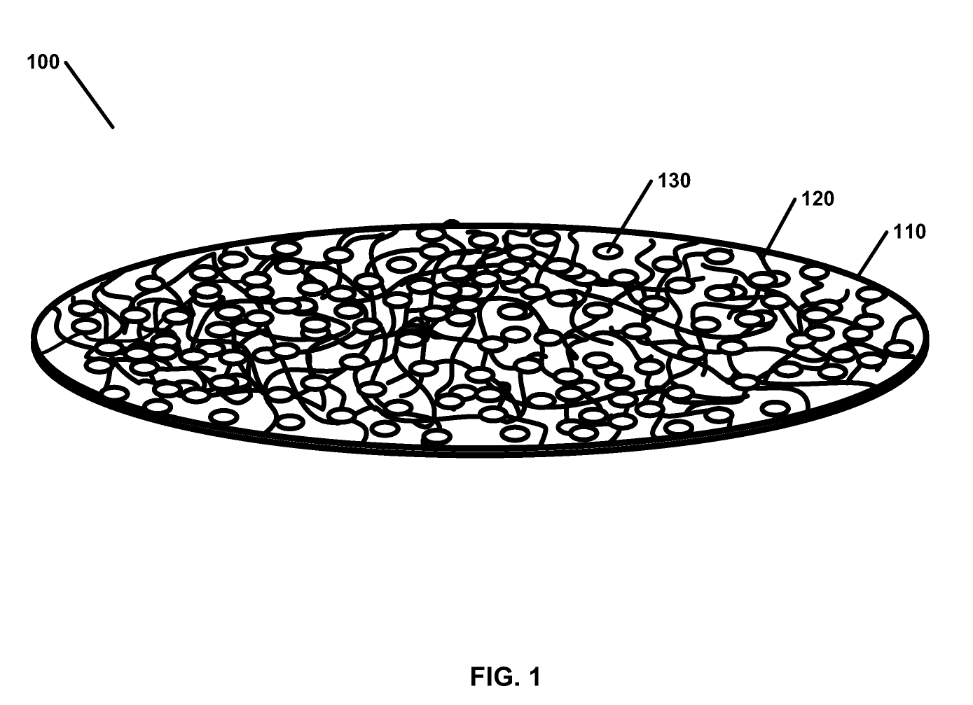

Example FIG. 1 illustrates a filter composition in accordance with one aspect of embodiments.

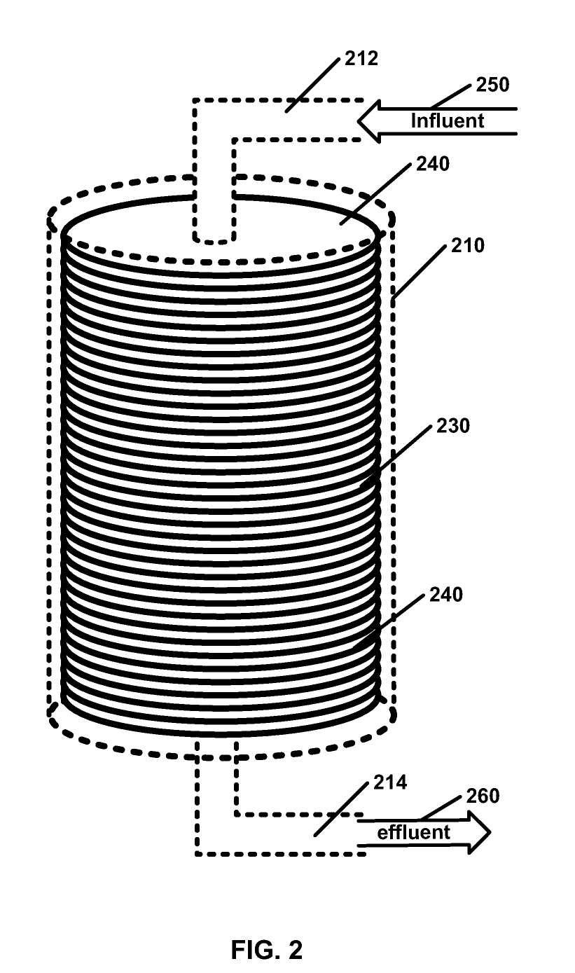

Example FIG. 2 illustrates a filter apparatus in accordance with one aspect of embodiments.

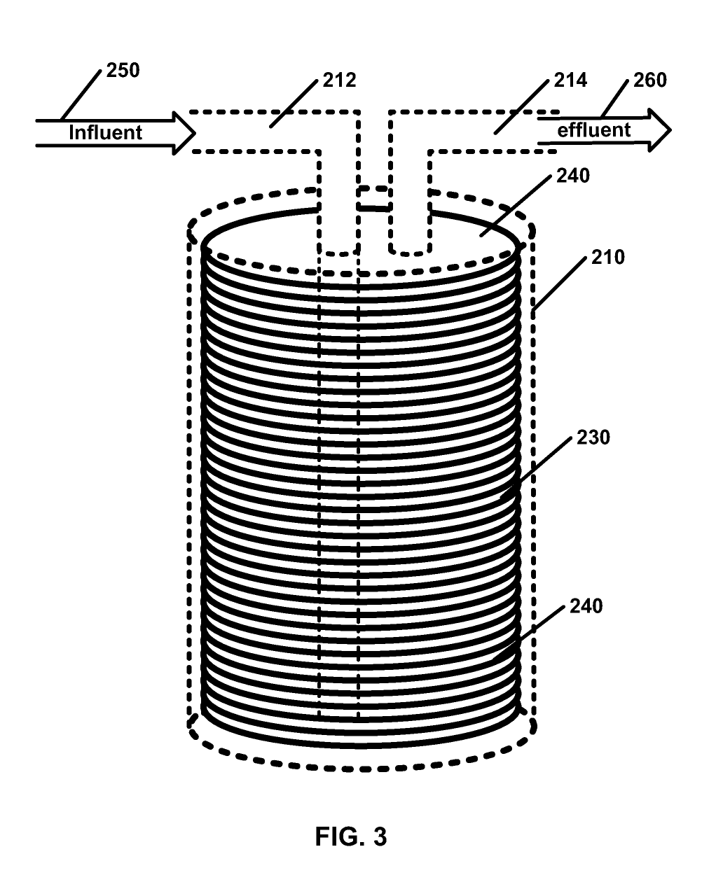

Example FIG. 3 illustrates a filter apparatus in accordance with one aspect of embodiments.

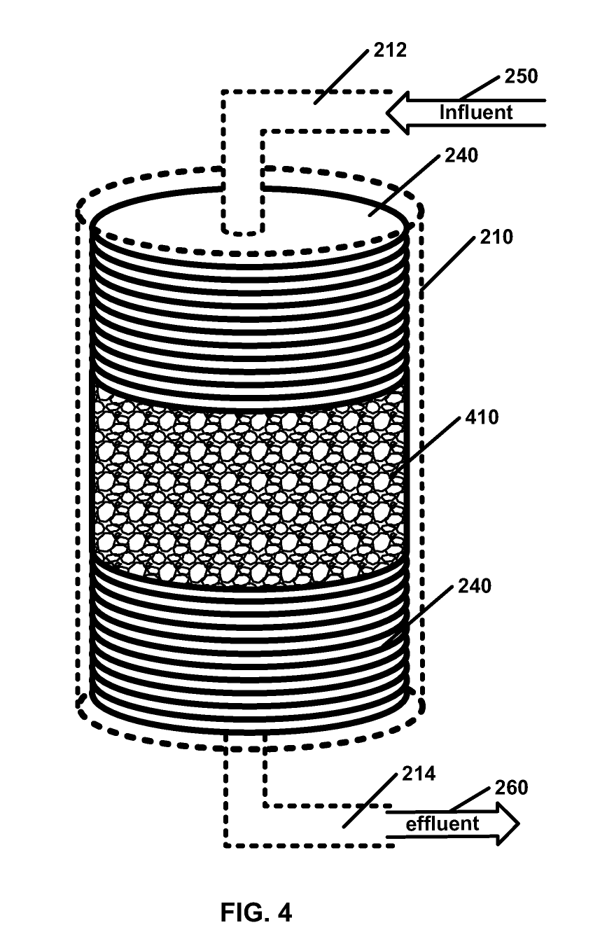

Example FIG. 4 illustrates a filter apparatus in accordance with one aspect of embodiments.

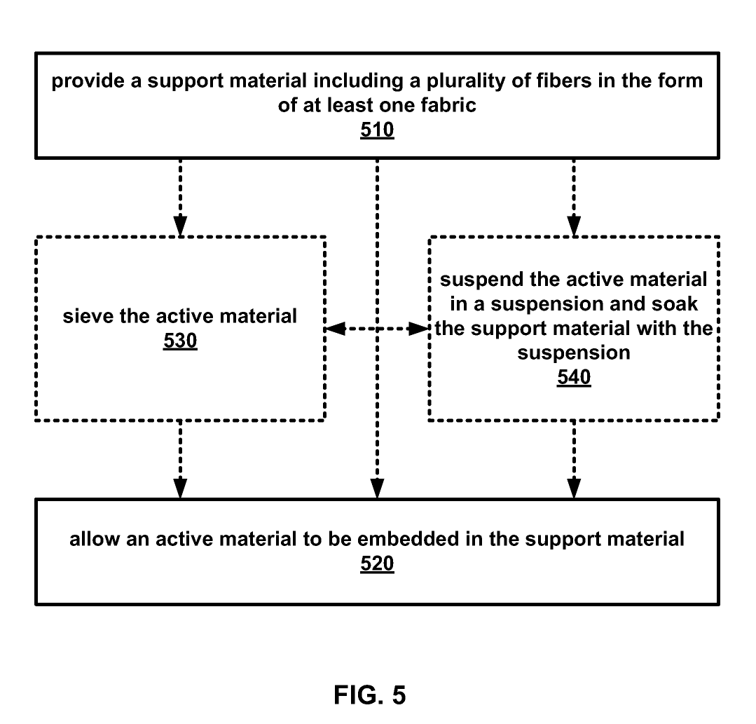

Example FIG. 5 illustrates a process of forming a filter composition in accordance with one aspect of embodiments.

Example FIG. 6 illustrates a filter apparatus in accordance with one aspect of embodiments.

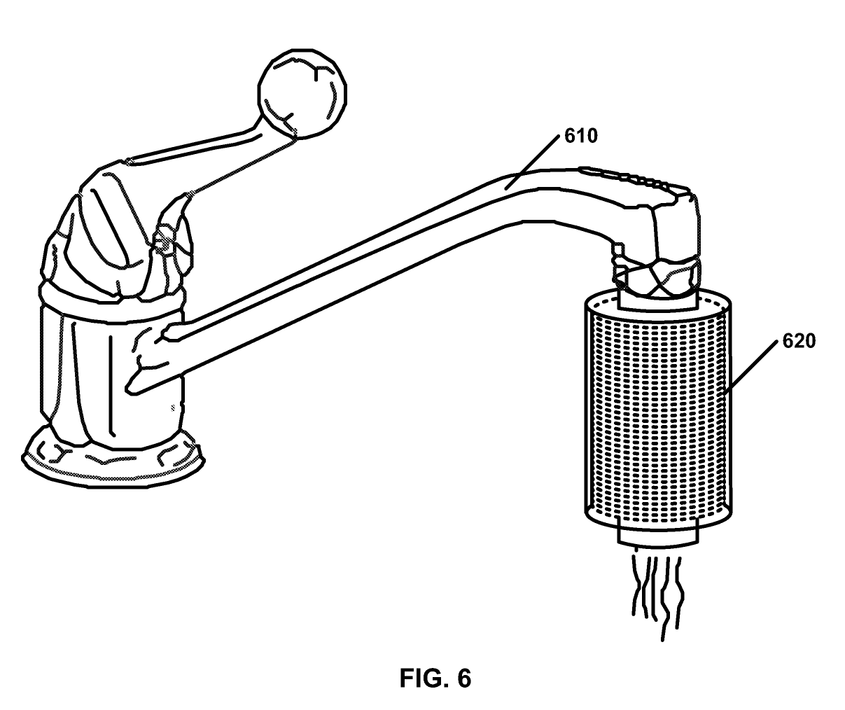

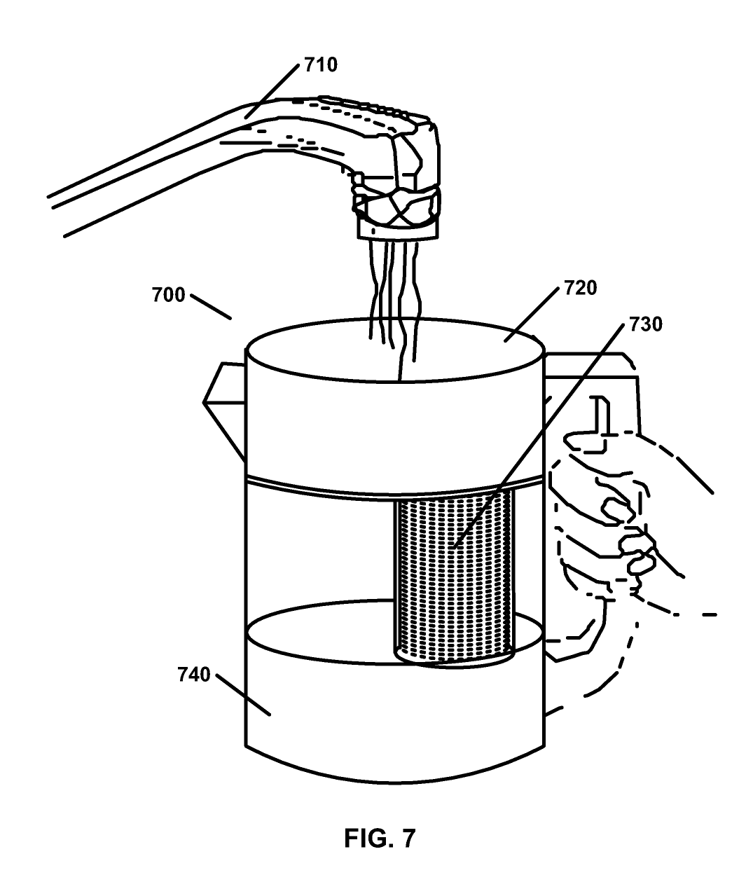

Example FIG. 7 illustrates a filter apparatus in accordance with one aspect of embodiments.

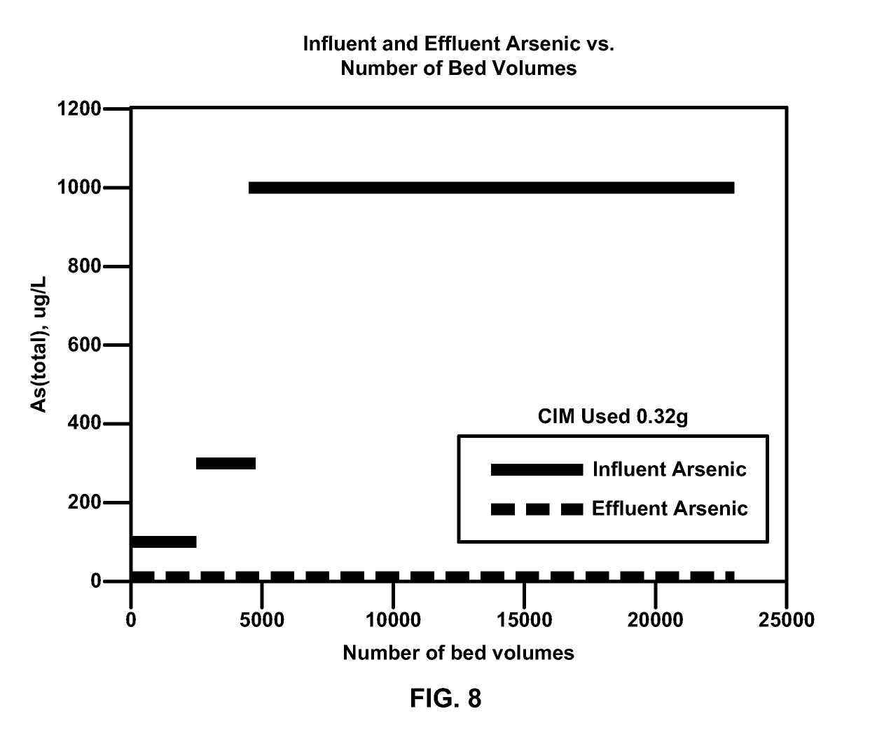

Example FIG. 8 illustrates filtration capacity in accordance with one aspect of embodiments.

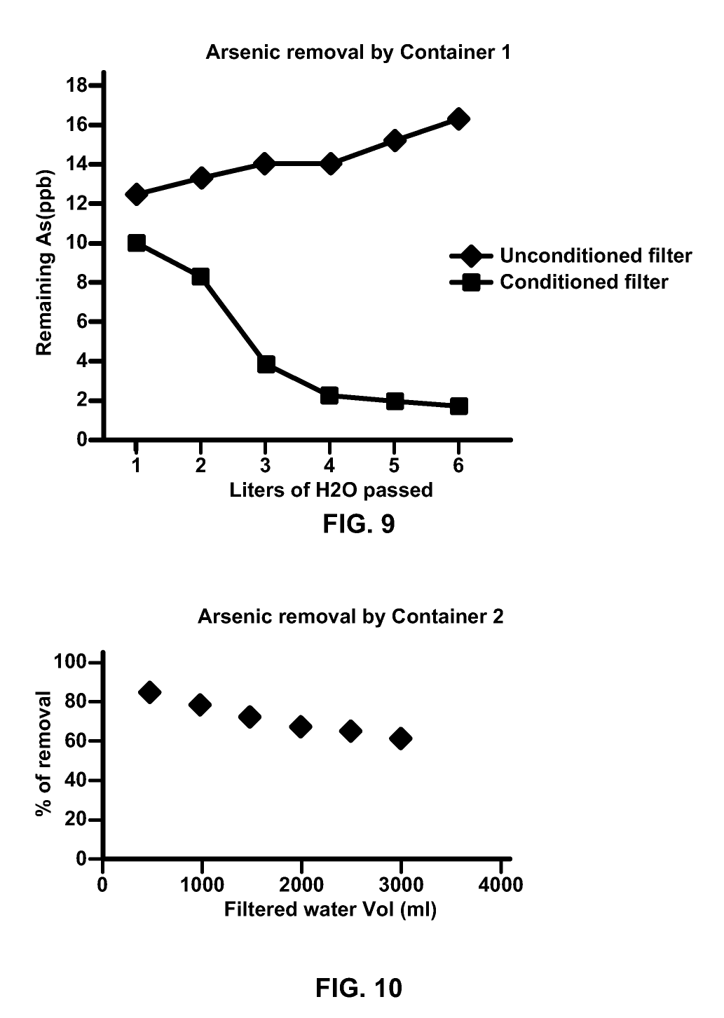

Example FIG. 9 illustrates filtration capacity in accordance with one aspect of embodiments.

Example FIG. 10 illustrates filtration capacity in accordance with one aspect of embodiments.

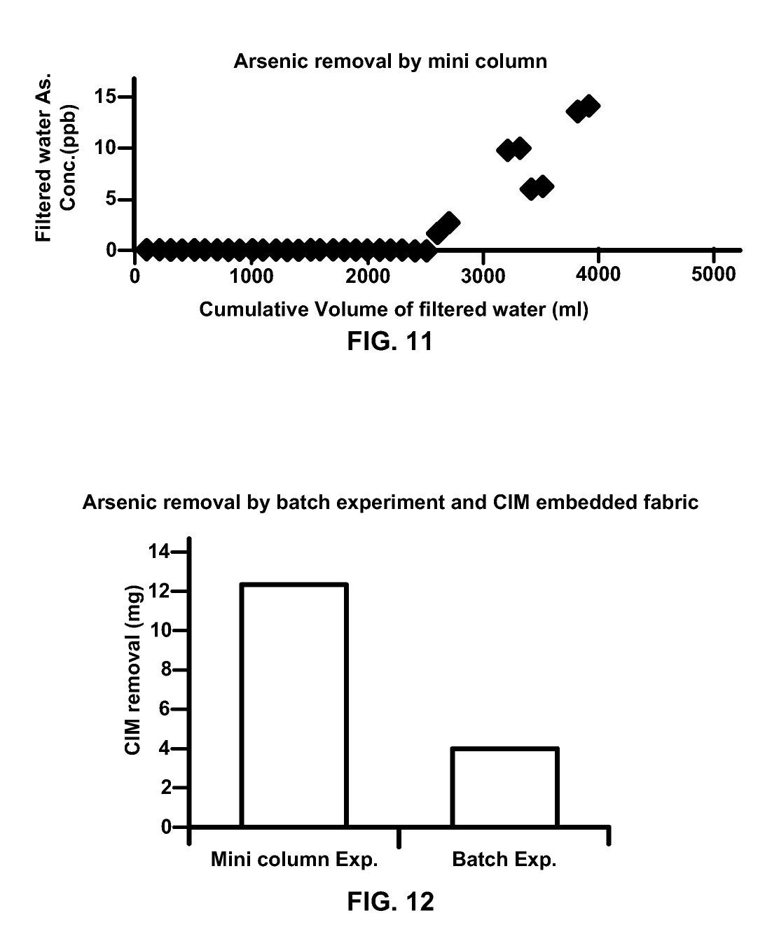

Example FIG. 11 illustrates filtration capacity in accordance with one aspect of embodiments.

Example FIG. 12 illustrates filtration capacity in accordance with one aspect of embodiments.

### DESCRIPTION

Embodiments relate to filters and/or processes thereof. Some embodiments relate to a filter apparatus, a process of filtering a target, a process of forming a filter composition and/or a filter composition. In embodiments, filtration capacity may be maximized and/or breakthrough may be minimized.

According to embodiments, a filter composition may include one or more active materials and/or one or more support materials. Referring to example FIG. 1, a filter composition is illustrated in accordance with one aspect of embodiments. In embodiments, filter composition 100 may include support material 110. In embodiments, support material 110 may include one or more fibers 120. In embodiments, one of more fibers 120 may include one or more polymers, and/or may be in the form of a matrix, for example a fabric matrix. In embodiments, filter composition 100 may include one or more active materials 130. In embodiments, one or more active materials 130 may be embedded in support material 110, for example embedded in a matrix formed by one or more fibers 120.

According to embodiments, an active material may include metal and/or non-metal components, for example iron, manganese, carbon, phosphorous, aluminum, silicon, cerium, sulfur, chromium, copper and/or zinc. In embodiments, an active material may include Composite Iron Matrix (CIM) material, which is described in U.S. patent application Ser. No. 12/524,906 to Hussam, the entire contents of which is hereby incorporated by reference. In embodiments, an active material may include homogenous and/or heterogeneous particles, for example with reference to morphology and/or composition.

According to embodiments, an active material may include particles having different size, shape and/or composition. In embodiments, active material may include relatively small embedded particles, for example particles having an average diameter less than approximately 250 μm. In embodiments, embedded particles may be present in any suitable amount. In embodiments, embedded particles may be present in an amount greater than approximately 1.0 g/m², for example between approximately 1.0 g/m² and 4.0 g/m².

According to embodiments, iron may be present in an amount between approximately 68% and 92% by weight of an active material. In embodiments, manganese may be present in an amount between approximately 0.2% and 3% by weight of an active material. In embodiments, carbon may be present in an amount between approximately 1% and 5% by weight of an active material. In embodiments, phosphorous may be present in an amount between approximately 0.05% and 2% by weight of an active material. In embodiments, aluminum may be present in an amount of at least approximately 0.01% by weight of an active material. In embodiments, silicon may be present in an amount between approximately 1% and 2% by weight of an active material.

According to embodiments, cerium may be present in an amount of at least approximately 4 μg per gram of an active material. In embodiments, sulfur may be present in an amount between approximately 300 μg per gram of an active material and 1000 μg per gram of an active material. In embodiments, chromium may be present in an amount between approximately 300 μg per gram of an active material and 500 μg per gram of an active material. In embodiments, copper may be present in an amount between approximately 300 μg per gram of an active material and 600 μg per gram of an active material. In embodiments, zinc may be present in an amount between approximately 8 μg per gram of an active material and 20 μg per gram of an active material.

According to embodiments, a support material may include one or more fibers. In embodiments, one or more fibers may include one or more polymers, which may be synthetic and/or natural polymers. In embodiments, a synthetic polymer may include any suitable polymer, for example polycarbonate, polyester, polypropylene, polystyrene and/or nylon. In embodiments, a natural fiber may include any suitable fiber, for example cellulose and/or microtubules. In embodiments, one or more fibers may be in the form of a matrix, for example a fabric matrix. In embodiments, a fabric may include a cloth, for example manufactured by weaving, knitting and/or or felting fibers.

According to embodiments, one or more fibers may be homogenous and/or heterogeneous, for example with reference to morphology and/or composition. In embodiments, a fabric may include polymers of different composition, weight, size, isomerism and/or porosity, for example a fabric including two or more copolymers. In embodiments, a fabric may include polymers which are physically and/or chemically cross-linked. In embodiments, a fabric may include substantially the same and/or varying thread counts.

According to embodiments, a filter apparatus may include one or more filter compositions. In embodiments, a filter apparatus may include an active material, for example a material including iron, manganese, carbon, phosphorous, aluminum, silicon, cerium, sulfur, chromium, copper and/or zinc. In embodiments, a filter apparatus may include a support material which may be in the form of a fabric. In embodiments, one or more active materials may be physically embedded in one or more fabrics.

According to embodiments, one or more fabrics having one or more active materials may be disposed in a housing. In embodiments, a housing may include any suitable material and/or be in any desired shape. In embodiments, a housing may include plastic, glass, ceramic, metal, silicon and/or ceramic material. In embodiments, a housing may have one or more portions that are opaque, translucent and/or transparent. In embodiments, a housing may include a cylinder, cone, square, rectangle and/or amorphous shape, and/or may include one or more removable portions. In embodiments, one or more fabrics may be removeably and/of replaceably disposed in a housing, and/or may be in any configuration. In embodiments, one or more fabrics may be disposed in a housing in a stacked configuration, horizontal and/or vertical configuration. In embodiments, a housing may include any selected dimension, for example a length of approximately 9.0 cm and a diameter of approximately 1.5 cm.

Referring to example FIG. 2, a filter apparatus may include a plurality of filter compositions 230, 240 disposed in housing 210. In embodiments, filter compositions may be substantially the same and/or different. In embodiment, for example, filter composition 230 may include a different weight percent of iron than filter composition 240, may have an average diameter particle size larger than the average particle size of filter composition 240, and/or include a support material having different composition and/or morphology than filter composition 240.

As illustrated in one aspect of embodiments in FIG. 2, housing 210 may be in the approximate form of a cylinder, and/or filter compositions 230, 240 may be round cut to form a filter stack in a housing. Housing 210 may include an input, for example input 212 to input influent 250, and/or may include an output, for example output 214 to output effluent 260 in one aspect of embodiments. In embodiments, influent may include a target, and/or effluent may include relatively less target than influent, which may include substantially no target and/or an accepted amount of target for a desired use. In embodiments, one or more fabric compositions may sequester one or more targets.

According to embodiments, influent may be admitted to housing 210 and/or effluent may leave housing 210 by any suitable process, including pressure and/or gravity. In embodiments, input 212 and/or output 214 may be any suitable input and/or output, including an opening, a valve, a stopper, a pipe and/or a spigot. In embodiments, housing 210 may include one or more removable portions, for example a removable portion of a sidewall, such that influent, effluent and/or a filter composition may be added, deleted and/or replaced.

According to embodiments, an input and/or output may be included at any location of a housing. Input 212 may be on an opposite side of housing 210 relative to output 214, as illustrated in one aspect of embodiments in FIG. 2, and/or input 212 may be on the same side of housing 210 relative to output 214, as illustrated in one aspect of embodiments in example FIG. 3. In embodiments, a portion of an input and/or an output may be adjacent a side of a housing and/or may be partially and/or completely disposed in a housing. As illustrated in one aspect of embodiments in FIG. 3, a portion of input 212 may be disposed in housing 210 and/or a portion of output 214 may be adjacent a side of housing 210. In embodiments, a portion of an input and/or an output may traverse one or more filter compositions. In embodiments, an input may employ the same flow path as an output.

According to embodiment, a filter apparatus may include one or more layers of other components. In embodiments, other components may include sand, sand-charcoal, sand-brick chips and/or sand-gravel interface. As illustrated in one aspect of embodiments in example FIG. 4, one or more layers 410 may be disposed between filter composition 240. In embodiments, any suitable combination of component layers and filter compositions may be employed, including within the same housing and/or across a plurality of housings, in any arrangement such as in series and/or in parallel arrangements.

According to embodiments, a filter composition and/or a filter apparatus may be employed to filter a liquid, which may carry a target to be sequestered. In embodiments, inorganic and/or organic material may be removed from a liquid, for example toxic and/or non-toxic anions and/or cations. In embodiments, arsenic, for example As(III) and/or As(V), chromate, for example Cr(VI), cadmium, for example Cd(II), manganese, zinc, lead and/or other heavy metal ions may be removed from a liquid, which may include water. In embodiments, a fluid contacting one or more filter compositions to filter one or more targets may include allowing a fluid to pass through one or more filter compositions.

According to embodiments, a process of filtering a target may include providing a support material, allowing an active material to be embedded in a support material and/or allowing a target to contact a filter composition. According to embodiments, a process of filtering a target may include removing one or more targets from a liquid. In embodiments, a liquid may include water, for example fresh water, such as tap, distilled, deionized, well, lake, pond, river, stream, portable and/or well water. In embodiments, a filtered liquid may be used for any suitable purpose, for example for consumption and/or industrial use. Industrial use may include, for example, biomedical and/or manufacturing use.

As illustrated in one aspect of embodiments in FIGS. 2 and 3, influent 250 is admitted to housing 210 through input 212, passes through filter compositions 230, 240 and leaves housing 210 as effluent 260 through output 214. As illustrated in one aspect of embodiments in example FIG. 4, influent 250 is admitted to housing 210 through input 212, passes through filter composition 240 and component layer 410, and leaves housing 210 as effluent 260 through output 214. In embodiments, influent may be water including arsenic, and/or filter compositions 230, 240 may include one or more fibers in the form of one or more fabrics having one or more active materials embedded therein, disposed in housing 210 in a stacked configuration.

According to embodiments, for example where water is filtered for consumption, a filter composition and/or device may be employed in a home, in a water plant and/or therebetween. Referring to example FIG. 6, a filter apparatus is illustrated in accordance with one aspect of embodiments. In embodiments, filter apparatus 620 may include one or more filter compositions. In embodiments, filter apparatus 620 may be configured to be removeably attached to faucet 610, for example including a threaded portion that cooperates with a corresponding faucet threaded portion. In embodiments, water exiting faucet 610 may be admitted to filter apparatus 620 and contact one or more filter compositions. In embodiments, water contacting one or more filter compositions may be allowed to exit filter apparatus 620 such that effluent includes a reduced concentration of a target, which may be a substantially free amount of a target. In embodiments, a fluid contacting one or more filter compositions may include allowing a fluid to pass through one or more filter compositions.

Referring to example FIG. 7, a filter apparatus is illustrated in accordance with one aspect of embodiments. In embodiments, filter apparatus 730 may include one or more filter compositions. In embodiments, one or more filter composition may be removable from filter apparatus 730 and/or container 700, for example when a filter composition is saturated with target. Removing one or more filter compositions may be determined by any criteria, for example according to the volume of filtered fluid, lapsed time and/or visual inspection.

According to embodiments, water exiting faucet 710 may be admitted to reservoir 720 and contact one or more filter compositions. In embodiments, one or more reservoirs 720 and/or one or more filter apparatuses 730 may be removable from container 700. In embodiments, water contacting one or more filter compositions may be allowed to exit filter apparatus 730 such that effluent is collected in fluid chamber 740 of container 700. In embodiments, effluent may include a reduced concentration of a target, which may be a substantially free amount of a target. In embodiments, a target may be sequestered by one or more filter compositions. In embodiments, a fluid contacting one or more filter compositions may include allowing a fluid to pass through one or more filter compositions.

According to embodiments, a process of forming a filter composition may include providing a support material and/or allowing an active material to be embedded in a support material. Referring to example FIG. 5, a process of forming a filter composition is illustrated in accordance with one aspect of embodiments. In embodiments, a process of forming a filter composition may include providing a support material having one or more fibers, which may be in the form of one or more fabric 510. In embodiments, a process of forming a filter composition may include allowing an active material to be embedded in a support material 520. In embodiments, an active material may include iron, manganese, carbon, phosphorous, aluminum, silicon, cerium, sulfur, chromium, copper and/or zinc.

According to embodiments, a process of forming a filter composition may include any suitable process to provide a desired property of a filter composition, for example a desired dimension, elasticity, rigidity, porosity, tortuiosity, absorption and/or density of a filter composition. In embodiments, allowing an active material to be embedded in a support material may include maximizing active material surface area (m²) and/or particle density (g/m²). A process of forming a filtering composition may include sieving and/or separating an active material 530 as illustrated in one aspect of embodiments in FIG. 5. In embodiments, an active material may be sieved to separate an active material based on morphology, for example to provide active material including particles having an average particle size of 250 μm. In embodiments, an active material may be sieved for any reason, for example to purify an active material and/or to minimize particle size.

According to embodiments, a process of forming a filter composition may include suspending an active material in a suspension. A process of forming a filtering composition may include contacting support material with a suspension having an active material, for example by soaking a support material in a suspension 540, as illustrated in one aspect of embodiments in FIG. 5. In embodiments, an active material may be processed, for example ground, sieved, and/or filtered prior to soaking a support material in a suspension. In embodiments, a support material may be soaked by placing a support material in a suspension and/or depositing a suspension on one or more sides of a support material.

According to embodiments, the filtration capacity of a filter composition and/or filter apparatus may be maximized. In embodiments, filtration capacity may be greater than approximately 30 mg of target per gram of embedded active material. Filtration capacity may be relatively higher than related 10 mg capacity, although any capacity may be selected for a filtration composition, apparatus and/or process in accordance with aspects of embodiments. In embodiments, approximately 1 gram of embedded active material may remove approximately 100 μg/L of arsenic from approximately 50 gallons (approximately 200 L) in water.

Referring to example FIG. 8, filtration capacity is illustrated in accordance with one aspect of embodiments. In embodiments, approximately 3.1 mg of arsenic may be substantially completely sorbed per gram of embedded active material. In embodiments, arsenic content may be below the detection limit of a sensor, for example a Hydride Generation Atomic Fluorescence Spectrometer (HGAFS), which may be approximately 100 parts-per-trillion (approximately a nanogram per liter), for example when 100, 300 and/or 1000 μg/L of arsenic contacts a filter composition in a approximate 16.0 mL filter apparatus. In embodiments, water may contact a filter composition at any desired rate, for example at a rate between approximately 1.8 mL/min and 2.0 mL/min.

According to embodiments, breakthrough may be minimized. In embodiments, there may be no substantial breakthrough even when influent may include approximately 100 times the United States Environmental Protection Agency limit for arsenic in drinking water.

### Example Filter Embodiments

### A. Overview

Preparation and/or testing efficiency of three filters was examined. CIM was embedded in two different types of polyester filter fabrics to prepare two relatively small filters, a first filter used in a Brita-type pitcher (filter BCF/Container 1) and a second filter used in a Rubbermaid type pitcher (filer DBF/Container 2), to filter drinking water. In one aspect of embodiments, approximately 3.6 g CIM material was embedded including a surface density of approximately 2.5 g/m². A third filter was made in accordance with one aspect of embodiments illustrated in FIG. 2 and/or FIG. 8 (filter F2/Mini Column), where a total bed volume of approximately 16-18 ml and a surface density of 55.6 g CIM/m² with a flow rate of approximately 1.8 ml/min was employed.

Upon testing with 100 ppb, filter BCF provided approximately 75% removal on average for the first 6.0 L when unconditioned. Approximately 96% removal was observed for the first 6.0 L for a conditioned filter BCF. For filter DBF, approximately 60% removal was observed, on average. For filter F2, removal to concentration below 10 ppb target in effluent was achieved from a 4.0 L influent sample having 1000 ppb arsenic, and a capacity was calculated to be between approximately 12.3-30.0 mg As/g CIM material (embedded).

### B. Embodiment Processes, Compositions and/or Devices

### 1. Embodiment Filter Compositions

Two different fabrics were selected for CIM embedding. One was polyester (approximately 0.05 cm thick) and the other was relatively bulky polyester (thickness approximately 0.40 cm). The fabrics were cut out pieces of approximately 5×5 and 10×10 cm size. The CIM was grounded and sieved through a 60 mesh (approximately 250 micron or 0.250 mm) standard testing strainer. A suspension of CIM was prepared in a ratio of approximately 1.0 g/100 mL DI water. The fabrics of approximately 5×5 cm pieces were soaked in a 500 mL plastic beaker containing the CIM suspension of approximately 500 mL and 5.0 g of CIM, accompanied with discontinuous stifling over night. The fabrics were weighted and numbered before placing into the CIM suspension.

The following day, the fabrics turned a dark brownish color and were embedded with CIM. The fabrics were taken out and air dried. The substantially dry fabrics were weighted. Continued stirring appeared to be more effective in embedding compared to a process which omitted the use of a stirrer. The quantity of CIM embedding was calculated by the gravimetric method. The CIM embedding data for the approximate 5×5 cm pieces of the fabric was recorded, and is illustrated in Example Table 1, discussed below. On an average, the CIM sorption was found to be between approximately 2.5 and 55.6 g/m² in relatively thin and thick fabric, respectively. However, any sorption may be provided by modifying peramaters, for example particle size, embedding processes and/or support material.

### 2. Embodiment Filter Apparatus

A Brita-type column with changing cone radius of 2.0 and 2.5 cm was used. CIM embedded fabrics were cut out in the approximate shape of a circle, with a radius of 2.0 cm and 2.5. Two filters were made using the two different type CIM embedded fabrics. Relatively thin fabrics were used to make filter BCF and relatively thicker fabrics were used to make filter DBF. The compartment housing the filter compositions were filled substantially completely with CIM embedded fabrics. A total of 364 thin circular pieces of fabric were used for filter BCF and 156 thick pieces were used for filter DBF. The calculated amount of CIM in filter BCF and/or filter DBF was between approximately 2.5 and 55.6 g/m², respectively.

Arsenic solution was allowed to flow through the column bed (top to bottom; end flow mode) and to drain out. For filter BCF, arsenic (III) spiked DI water samples (100 ppb) were passed with a down flow direction at a flow rate of approximately 38.5 mL/min to evaluate column efficiency for arsenic (III) removal. The effluent filtered water was sampled at approximately every 1.0 L until the completion of the experiment. For filter DBF, 100 ppb arsenic (III) solution was passed through with substantially the same flow rate.

A third filter apparatus was manufactured in accordance with one aspect of embodiments as illustrated in example FIG. 2. Filter fabric (e.g., polyester) was used as a support material. It was a relatively coarse and thick material, for example having a thickness of approximately 0.4 cm. This column was made with 33 circular pieces having a CIM loading density of approximately 55.6 g/m² to substantially fill the column.

The substantially dried cloths were cut into an approximate shape of a circle with the radius of approximately 0.8 cm. The CIM embedded fabrics were relatively tightly packed to create part of a mini column. A total of 33 pieces were wet-packed in an approximate 5.2 inch (13.2 cm) column height. The area of each circular piece was the surface area of the disk.

### 3. Embodiment Chemicals Used

Chemicals used were analytical grade, and substantially all stock solutions were prepared with double distilled water from a Millipore purification system (Billerica, Mass., USA). Glass materials and plastic bottles were washed with distilled water and exposed overnight to a 5% nitric acid solution. The standard stock As (III) solution (1000 mg/L) was prepared by the dissolution of reagent grade NaAsO₂ in approximate 1.0 L double distilled water containing approximately 0.1% ascorbic acid. This solution was kept refrigerated in an amber bottle. An approximate 1.0 mg/L working stock solution was made by dilution with approximately 0.1% ascorbic acid solution and refrigerated in an amber bottle. Dilute As (III) standards were prepared daily. The reducing solution was sodium borohydride (NaBH₄, Sigma-Aldrich, USA) approximately 0.7% (m/v) in approximately 0.5% (m/v) sodium hydroxide (ACS grade). The HCl (Sigma-Aldrich, USA) concentration of approximately 3.0 M was prepared contained approximately 1% KI and 0.2% ascorbic acid.

### 4. Embodiment Analytical Methods

Automated Hydride Generation Atomic Fluorescence Spectrometer (HGAFS) was used for determination of arsenic to trace and ultra trace levels. The gaseous products were flushed from the gas/liquid separator by a controlled stream of purge gas, for example argon. As the reaction liquids are pumped into the separator and the purge gas carries the gaseous products into the measurement system, a pressure differential is set up the two arms of the U-tube. The gaseous products from the gas/liquid separator pass through a Perma Pure Dryer System to the detector. A boosted hollow cathode arsenic lamp excitation source was used to excite the atomized arsenic and obtain the fluorescence spectrum.

A flow injection-hydride generation-atomic florescence spectrometry (FI-HG-AFS) technique was used for determination of arsenic in the samples. The system was maximized with approximately 3.0 M HCl, flow rate of approximately 4.5 ml min⁻¹, 0.7% NaBH₄ flow rate of approximately 2 ml min⁻¹ and carrier gas (e.g., argon) flow rate of approximately 325 ml min⁻¹. In the FI-HG-AFS system, the sample was introduce into a carrier stream of approximately 3.0 M HCl in approximately 1% KI and 0.2% ascorbic acid using a peristaltic pump. The sample, together with carrier solution, met subsequently with a continuous stream of NaBH₄ dissolved in approximately 0.5% sodium hydroxide. Mixing HCl with NaBH₄ generated hydride (arsine), which subsequently entered into the gas-liquid separator apparatus. Concentration of NaBH₄ should be maintained to ensure flame ignition. The stability of the flame is dependent on the regulation of H₂ gas flow. The reaction is as follows:

As(O)(OH)₃+H⁺+BH₄⁻→As(OH)₃+H₂O

As(OH)₃+3BH₄⁻+3H⁺→AsH₃+3BH₃+3H₂O

BH₃+H₂O→H₃BO₃+H₂

The hydrides and excess hydrogen are swept out of the generation vessel using a stream of argon into a chemically generated hydrogen diffusion flame. The hydrides are atomized and the resulting atoms are detected by atomic fluorescence. Peak signals were recorded using a computer linked to the atomic florescence spectrophotometer (AFS) that is capable of both peak height and peak area measurement. The detection limit of our HG-AFS with 95% confidence level was 1 μg/L for arsenic.

Samples were prepared. Approximately one milliliter of filtered water and 4.0 mL of reagent (approximately 3.0 M HCl in 1% KI and 0.2% ascorbic acid) solution was prepared, and analyzed after a period of time, for example at least after 30 minutes. The samples were made from each consecutive liters of arsenic (III) contaminated water passed through a filter.

### C. Embodiment Results

### 1. Embodiment Arsenic Sorption in Filter BCP

Filter BCP was used to examine arsenic removal efficiency without conditioning the filter. Conditioning for arsenic removal may allow oxidation and/or rusting of CIM and/or may maximize effectiveness. Example Table 1 illustrated arsenic removal efficiency and total volume of water filtered by the filter BCF before conditioning. The results of amount of arsenic removed began to decline as more and more liters of H₂O were passed through the column. On the 6th liter, the arsenic concentration was 16.1 ppb.

EXAMPLE TABLE 1
Unconditioned BCF. Influent As(III) 1000 ppb

| Filter ID: | Influent volume | Effluent As (III), | % of As |
|---|---|---|---|
| BCF (unconditioned) | filtered (ml) | ug/L or ppb | removal |
| 1 | 1000 | 12.3 | 75.4 |
| 2 | 2000 | 13.2 | 73.6 |
| 3 | 3000 | 13.9 | 72.2 |
| 4 | 4000 | 13.9 | 72.2 |
| 5 | 5000 | 15.1 | 69.8 |
| 6 | 6000 | 16.1 | 67.8 |

A filter column was filled with water for one week to maximize hydration of the CIM for the formation of hydrous ferric oxide (HFO) through oxidation and/or rusting, and thus conditioned for active sorption site generation. Thereafter, each day approximately 1 L of water containing 1000 ppb arsenic was passed though the filter to measure if there was a difference due to the conditioning. The results were promising, as each day after the first week of conditioning the concentration of arsenic in the water decreased and on the 6th liter, the concentration was 1.6 ppb much below the EPA 10 ppb limit for drinking water. The results are illustrated in example Table 2.

EXAMPLE TABLE 2
Conditioned BCF. Influent water As(III) 1000 ppb

| Filter ID: | Influent volume | Effluent | |
|---|---|---|---|
| BCF(conditioned) | of water (ml) | As(III) (ppb) | % of As removal |
| 1 | 1000 | 9.9 | 80.2 |
| 2 | 2000 | 8.2 | 83.6 |
| 3 | 3000 | 3.8 | 92.4 |
| 4 | 4000 | 2.2 | 95.6 |
| 5 | 5000 | 1.9 | 96.2 |
| 6 | 6000 | 1.6 | 96.8 |

A graph of the filtered water vs. the percent removal of arsenic is illustrated at example FIG. 9. A linear trend is observed in decreasing percent removal of arsenic with increasing total volume water passed through filter BCP after conditioning.

### 2. Embodiment Arsenic Sorption in Filter DBF

Filter DBF was prepared using a polypropylene bottle that had a radius of approximately 2.0 cm. Fabrics, approximately 0.4 cm thick polyester in an amount of 156 circular pieces, were used to make this bottle cartridge. This system is designed like a table-top water filter. A reservoir that is connected to a filter apparatus at a lower sidewall is fitted in a Rubbermaid-type container. About 500 ml water may be filtered at a time before filling up. Using this system, 6.0 L of water was filtered; however it was not conditioned first. The CIM embedded in the support material was approximately 2.5 grams, as illustrated in example Table 3.

EXAMPLE TABLE 3
Embedded CIM

| | | Mass of fabric | Mass of fabric | Amount |
|---|---|---|---|---|
| | Size of the | before CIM | after CIM | of CIM |
| Pieces of | fabric, cm² | embedding | embedding | embedded |
| fabrics | (±5%) | (±0.013 g) | (±0.011 g) | (±0.003 g) |
| 1 | 5 × 5 | 2.535 | 5.025 | 2.490 |
| 2 | 5 × 5 | 2.486 | 4.968 | 2.482 |
| 3 | 5 × 5 | 2.668 | 5.863 | 3.195 |
| 4 | 5 × 5 | 2.963 | 5.486 | 2.523 |
| 5 | 5 × 5 | 2.789 | 4.496 | 1.707 |
| 6 | 5 × 5 | 2.476 | 5.774 | 3.298 |
| 7 | 5 × 5 | 2.842 | 5.493 | 2.651 |
| 8 | 5 × 5 | 2.505 | 5.07 | 2.565 |
| 9 | 5 × 5 | 2.548 | 4.978 | 2.430 |
| 10 | 5 × 5 | 2.576 | 4.469 | 1.893 |
| Average: | 5 × 5 | 2.639 | 5.162 | 2.523 |

The flow rate was approximately 500 ml/11 minutes. The relatively high flow rate and relatively less contact time could account for the effectiveness of this embodiment, as 60% of target in the first six liters of water was removed on average. The data is illustrated in example Table 4.

EXAMPLE TABLE 4
Arsenic Sorption in Filter DBF. Influent As(III) 300 ppb

| | Influent vol of water | Effluent | |
|---|---|---|---|
| Filter ID: DBF | filtered (ml) | As(III) (ppb) | % of As removed |
| 1 | 500 | 15.1 | 84.9 |
| 2 | 1000 | 21.2 | 78.8 |
| 3 | 1500 | 27.4 | 72.6 |
| 4 | 2000 | 32.4 | 67.6 |
| 5 | 2500 | 34.5 | 65.5 |
| 6 | 3000 | 38.4 | 61.6 |

A graph was plotted to show the percent removal by filter DBF. It shows relatively good results for the first two liters passed. The graph is illustrated at example FIG. 10. Modifying parameters, for example filter composition size and/or flow rate may enhance effectiveness.

### 3. Embodiment Arsenic Sorption in Filter F2

Approximately 4.0 Liters of 1000 ppb water was passed through a column as illustrated in one aspect of embodiments in FIG. 2. Removal of arsenic may be enhanced, as illustrated in one aspect of embodiments at FIG. 11. Generally, the sorption capacity for arsenic of CIM may be 4.25 mg As/g CIM. Comparing the sorption capacity of CIM with the sorption capacity of a filter embedded with CIM, there appears to be a capacity of approximately four times greater than previously achieved, for example 12.33 mg As/g CIM. The graph is illustrated at example FIG. 12. Without being bound to any theory, active material surface area (e.g., CIM size) and/or embedding in a matrix may enhance capacity.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described exemplary embodiments.

For example, while embodiments show faucet and/or pitcher filters, filters may be employed in any device and/or container, for example in refrigerators and/or dispensers. Furthermore, filter compositions and/or devices may be employed at any position of a liquid flow path, for example disposed at an intermediate portion of a pipe by threaded couplers, adhesive couplers, elastic couplers, soldered couplers, etc. Moreover, a filter composition may be employed without a housing, for example disposing one or more filter compositions directly in a container having water, which may include gravitational, mechanical, and/or magnetic process to enhance sequestering of a target.

As another non-limiting example, it may not be necessary to physically remove a filter composition, as any suitable process may be employed to desorb bound target to regenerate one or more filter compositions. Regeneration may be accomplished, for example, by washing one or more filter compositions with dilute aqueous sodium hydroxide and water, respectively. As a final non-limiting example, one or more filter compositions may be magnetically active and/or attracted to a magnetic filed, such that separation of species with similar magnetic properties, including paramagnetic species with externally induced magnetic fields, may be enhanced.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A filter apparatus comprising:
a. an active material comprising:
a) iron;
b) manganese;
c) carbon;
d) phosphorous;
e) aluminum; and
f) silicon; and
b. a support material comprising at least one fiber.

2. The filter apparatus of claim 1, wherein the active material further comprises:
a) cerium;
b) sulfur;
c) chromium;
d) copper; and
e) zinc.

3. The filter apparatus of claim 2, wherein the active material comprises:
a) iron in an amount between approximately 68% and 92% by weight of the active material;
b) manganese in an amount between approximately 0.2% and 3% by weight of the active material;
c) cerium in an amount of at least approximately 4 μg per gram of the active material;
d) carbon in an amount between approximately 1% and 5% by weight of the active material;
e) phosphorous in an amount between approximately 0.05% and 2% by weight of the active material;
f) sulfur in an amount between approximately 300 μg per gram of the active material and 1000 μg per gram of the active material;
g) aluminum in an amount of at least approximately 0.01% by weight of the active material;
h) silicon in an amount between approximately 1% and 2% by weight of the active material;
i) chromium in an amount between approximately 300 μg per gram of the active material and 500 μg per gram of the active material;
j) copper in an amount between approximately 300 μg per gram of the active material and 600 μg per gram of the active material; and
k) zinc in an amount between approximately 8 μg per gram of the active material and 20 μg per gram of the active material.

4. The filter apparatus of claim 1, wherein the at least one of the at least one fiber is a synthetic fiber.

5. The filter apparatus of claim 1, comprising a plurality of fibers in the form of at least one fabric.

6. The filter apparatus of claim 5, wherein the active material is embedded in at least one of the at least one fabric.

7. The filter apparatus of claim 6, wherein the active material comprises embedded particles having an average diameter less than approximately 250 μm.

8. The filter apparatus of claim 7, wherein the embedded particles are in an amount greater than approximately 1.0 g/m².

9. The filter apparatus of claim 5, comprising a plurality of fabrics disposed in a housing in a stacked configuration.

10. The filter apparatus of claim 9, wherein the plurality of fabrics and the housing are in the approximate shape of a cylinder.

11. The filter apparatus of claim 9, wherein the housing has a length of approximately 9.0 cm and a diameter of approximately 1.5 cm.

12. The filter apparatus of claim 5, comprising a filtration capacity of approximately 30 mg of target per gram of embedded active material.

13. A process of filtering a target comprising:
a. providing a filter composition comprising:
a) an active material including:
i. iron;
ii. manganese;
iii. carbon;
iv. phosphorous;
v. aluminum; and
vi. silicon; and
b) a support material comprising at least one fiber; and
b. allowing the target to contact the filter composition to sequester the target.

14. The process of filtering a target of claim 13, wherein the target comprises arsenic.

15. The process of filtering a target of claim 13, wherein:
a. the target is disposed in a fluid carrier;
b. the support material comprises a plurality of fibers in the form of at least one fabric;
c. the active material is embedded in at least one of the at least one fabric;
d. the at least one fabric is disposed in a housing; and
e. the fluid is introduced into the housing, contacts the at least one fabric and exits the housing.

16. The process of filtering a target of claim 15, comprising a plurality of fabrics in a stacked configuration.

17. A process of forming a filter composition comprising:
a. providing a support material including a plurality of fibers in the form of at least one fabric; and
b. allowing an active material to be embedded in the support material, the active material comprising:
a) iron;
b) manganese;
c) carbon;
d) phosphorous;
e) aluminum; and
f) silicon.

18. The process of forming a filter composition of claim 18, comprising sieving the active material.

19. The process of forming a filter composition of claim 17, comprising:
a) suspending the active material in a suspension; and
b) soaking the support material with the suspension.

20. A filter composition comprising:
a. an active material comprising:
a) iron;
b) manganese;
c) carbon;
d) phosphorous;
e) aluminum; and
f) silicon.
b. a support material comprising at least one fiber.
